(19) United States
(12) Patent Application Publication
(10) Pub. No.: US 2016/0217278 A1
(43) Pub. Date: Jul. 28, 2016

(54) AUTHENTICATION APPARATUS AND AUTHENTICATION METHOD THAT REGISTER FINGERPRINT DATA FOR COLLATION EASILY

(71) Applicant: KYOCERA Document Solutions Inc., Osaka (JP)

(72) Inventor: Ryo SHIOMI, Osaka (JP)

(73) Assignee: KYOCERA Document Solutions Inc., Osaka (JP)

(21) Appl. No.: 15/007,716

(22) Filed: Jan. 27, 2016

(30) Foreign Application Priority Data
Jan. 27, 2015 (JP) 2015-013266

(51) Int. Cl. G06F 21/32; G06K 9/00

(52) U.S. Cl. CPC G06F 21/32; G06K 9/00013

(57) ABSTRACT

Provided is an authentication apparatus that can register the fingerprint data for collation for comparing with the read fingerprint data, easily. A fingerprint reading part reads fingerprint data at the time of the touch operation of the input identification code. A fingerprint data collating part, specifies authentication identification code and authenticates a user by comparing the read fingerprint data and the authentication fingerprint data associated with the authentication identification code and stored in the memory part. Authentication-fingerprint-data registering part, when the authentication fingerprint data correspond with the read fingerprint data are not stored, and when the authentication identification code corresponded with the input identification code is stored, associates the read fingerprint data with the authentication identification code corresponded with the input identification code as authentication fingerprint data and store it in the memory part.

### INCORPORATION BY REFERENCE

This application is based on and claims the benefit of priority from Japanese Patent Application No. 2015-013266 filed on Jan. 27, 2015, the contents of which are hereby incorporated by reference.

### BACKGROUND

The present disclosure is related with an authentication apparatus and authentication method that authenticate a user.

When an electronic apparatus, such as a copying machine and an MFP, is shared and used in an office, a user is authenticated by an authentication apparatus, use condition is grasped, and accounting management is performed.

For user authentication, method to input an identification code (personal ID and password) is common.

In a typical apparatus, input of the identification code is performed by using a manual entry or an IC card.

However, the operation that performs the manual entry of the identification code in every use are complicated.

Also, when the IC card is used for the input of the identification code, the complicated operation of the manual entry becomes unnecessary.

However, the IC card must be prepared for every user.

Accordingly, in recent years, another typical apparatus that authenticates a user without inputting an identification code by arranging a fingerprint sensor is proposed.

In this apparatus, the fingerprint sensor is arranged in piles to a telephone directory key, a start key, or the like, in an operation panel.

When a user touches these keys, fingerprint data is read, automatically, and the user is authenticated.

### SUMMARY

An authentication apparatus of the present disclosure is an authentication apparatus that authenticates a user by comparing an input identification code inputted by touch operation and an authentication identification code stored in a memory part. The authentication apparatus includes a fingerprint reading part, a fingerprint data collating part, and an authentication-fingerprint-data registering part. The fingerprint reading part reads fingerprint data at time of the touch operation of the input identification code. The fingerprint data collating part compares the fingerprint data read by the fingerprint reading part and an authentication fingerprint data, which is associated with the authentication identification code and is stored in the memory part. Thereby, an authentication identification code is specified and the user is authenticated. The authentication-fingerprint-data registering part, when the authentication fingerprint data that correspond with the fingerprint data read by the fingerprint reading part are not stored, and when the authentication identification code that corresponds with the input identification code is stored, associates the fingerprint data read by the fingerprint reading part with the authentication identification code that corresponds with the input identification code as authentication fingerprint data and stores in the memory part.

An authentication method of the present disclosure is an authentication method performed by the authentication apparatus that authenticates a user by comparing an input identification code inputted by touch operation and an authentication identification code stored in a memory part. Fingerprint data is read at the time of the touch operation of the input identification code. The read fingerprint data and the authentication fingerprint data that is associated with the authentication identification code and is stored in the memory part are compared. Thereby, an authentication identification code is specified, and the user is authenticated. Then, when the authentication identification code which the authentication fingerprint data which correspond with the read fingerprint data is not stored, and corresponds with the input identification code is stored. The read fingerprint data is used as authentication fingerprint data, is associated with the authentication identification code that corresponds with the input identification code, and stores in the memory part.

### BRIEF DESCRIPTION OF THE DRAWINGS

FIG. 1 is an outline schematic cross section showing an internal configuration of the embodiment in the authentication apparatus in the present disclosure;

FIG. 2 is a top view showing a configuration of an operation part illustrated in FIG. 1;

FIG. 3 is a block diagram showing schematic structure of the image forming apparatus illustrated in FIG. 1; and

FIG. 4 is a flow chart for explaining an authentication operation in the embodiment of the authentication apparatus in present disclosure.

### DETAILED DESCRIPTION

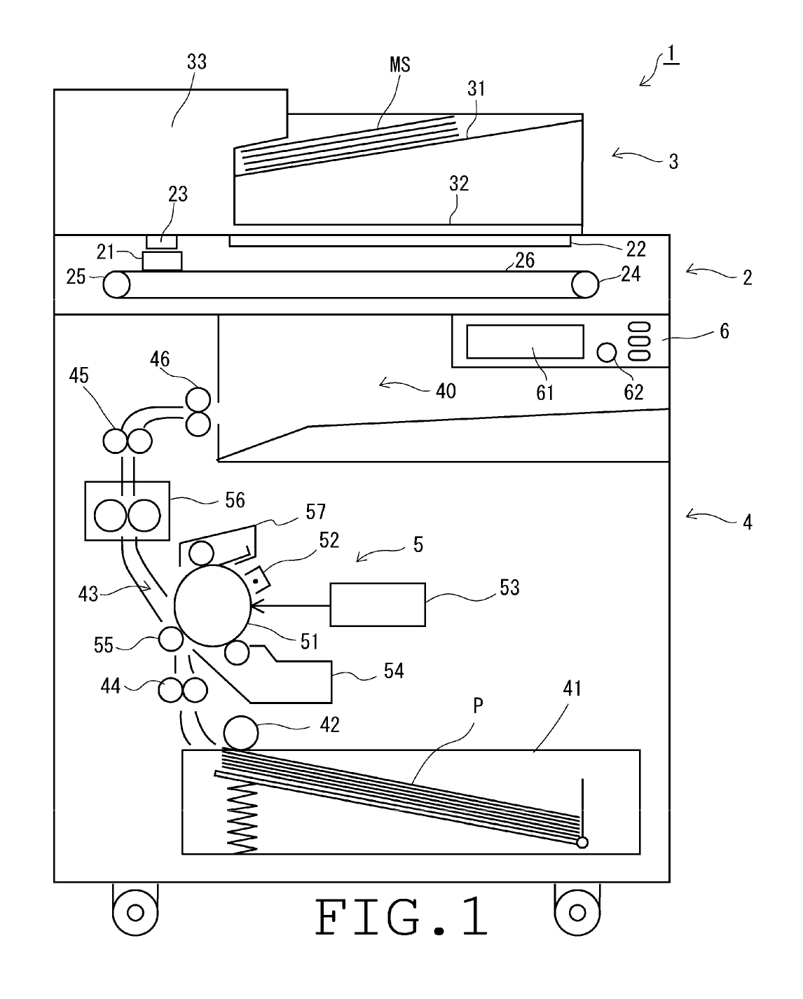

Next, the embodiment of the present disclosure is explained in detail with reference to drawings. An authentication apparatus in the present embodiment is an image forming apparatuses 1 by using an electrophotographying system, such as a copying machine and an MFP. When FIG. 1 is referred to, image forming apparatus 1 is provided with manuscript reading part 2, manuscript feeding part 3, body part 4, and operation part 6. Manuscript feeding part 3 is allocated in the upper part of manuscript reading part 2. Also, manuscript reading part 2 is allocated in the upper part of body part 4. Discharging space 40 is formed between manuscript reading part 2 and body part 4.

In operation part 6, touch panel 61 and manual operation button 62 are provided. A user performs various kinds of setup of image forming apparatus 1 by operating operation part 6 and inputting instructions. Also, various functions, such as scan operation and image formation, are performed. Touch panel 61 shows a state of image forming apparatus 1, or it displays an image formation situation and number of prints. Also, touch panel 61 can perform various setup, such as functions, such as double-side printing and tone reversal, a magnification setup, a density setup, or the like. As manual operation button 62, a start button, a stop button, a reset button, or the like, are provided. The start button instructs the start for scan operation or image formation. The stop button instructs the stop for scan operation or image formation. The reset button is used for making various setup of image forming apparatus 1 into a default.

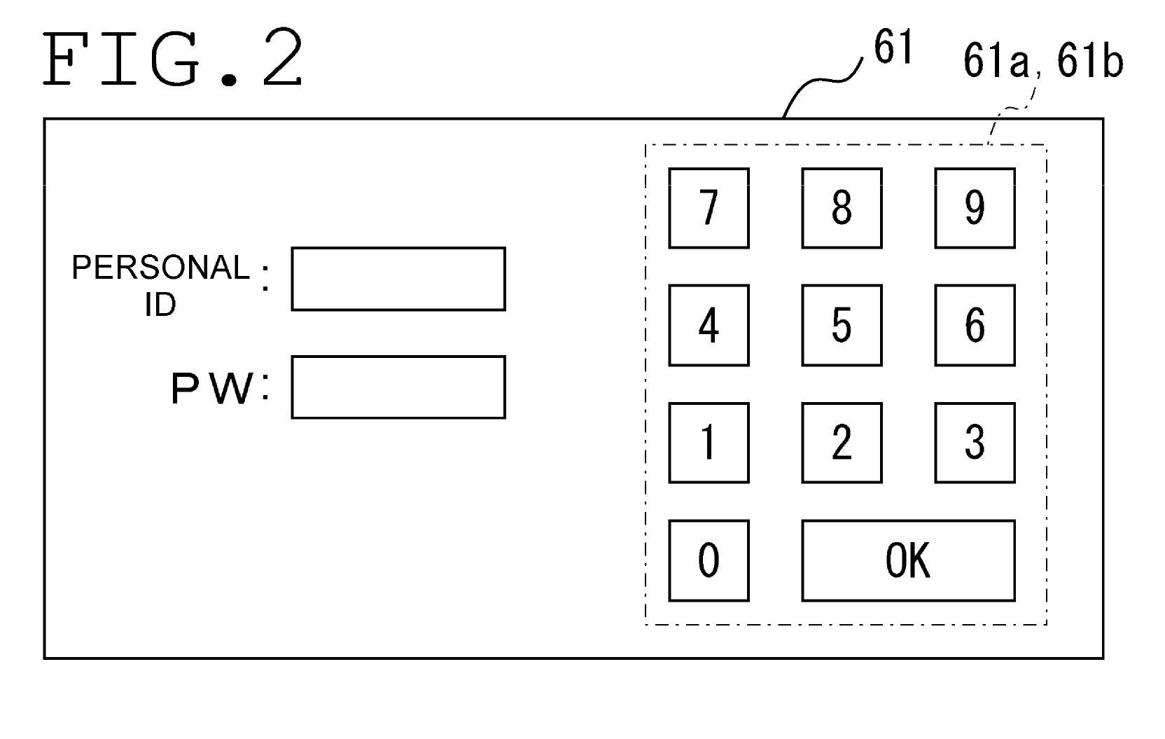

At the time of starting to use, an identification code input screen as shown in FIG. 2 is displayed. In this screen, inputting an identification code, such as personal ID and a password (PW), are prompted by touch panel 61. In the identification code input screen, identification code input part 61a is provided. Identification code input part 61a is a numeric keypad, a keyboard, or the like, which input the identification code by touching a finger. Also, identification code input part 61a is provided with the function as a publicly known fingerprint sensor that is made up with an electrostatic capacity type, an electric field detection type, a optical type, a thermal type, a pressure-sensitive type, or the like. Also, identification code input part 61a functions as fingerprint reading part 61b. The user touches touch panel 61 (identification code input part 61a) with a finger, in order to input the identification code. Then, fingerprint reading part 61b reads the fingerprint of the touched finger and outputs the signal corresponding to the position of unevenness by the fingerprint as fingerprint data. In addition, when taking a fingerprint, it is preferred to obtain a respective user's agreement.

Manuscript reading part 2 is provided with a light source and an image sensor. Manuscript reading part 2 leads the light of the light source of LED, a cold cathode tube light, or the like, to the image face of manuscript MS, and it leads the reflected light from the image face to image sensors, such as a CCD sensor. Manuscript reading part 2 is provided with scanner 21, platen glass 22, and manuscript reading slit 23. Scanner 21 is fixed to synchronous belt 26, which is stretched between motor 24 and pulley 25. By driving motor 24, scanner 21 is moved along the image face of manuscript MS placed on platen glass 22, and the image face of manuscript MS is scanned. Platen glass 22 is the manuscript stand composed of a transparent member, such as glass. Manuscript reading slit 23 is a slit formed in orthogonal orientation of the transportation direction for the manuscript by manuscript feeding part 3.

In case of reading manuscript MS placed on platen glass 22, scanner 21 is moved to a sub scanning direction along with platen glass 22. In this case, manuscript MS placed on platen glass 22 is scanned for each line of the main scanning direction. Thereby, image data is obtained and the obtained image data is outputted to body part 4. Also, when manuscript MS conveyed by manuscript feeding part 3 is read, scanner 21 is moved to the position that faces manuscript reading slit 23. In this case, manuscript MS is read by passing manuscript reading slit 23 with synchronizing the conveying action of the manuscript by manuscript feeding part 3. Thereby, image data is obtained and the obtained image data is outputted to body part 4.

Manuscript feeding part 3 is provided with manuscript mounting part 31, manuscript discharging part 32, and manuscript transport mechanism 33. Manuscript MS placed in manuscript mounting part 31 is fed out one sheet at a time in order by manuscript transport mechanism 33. Then, manuscript MS is conveyed in the position that faces manuscript reading slit 23. Manuscript MS is discharged by manuscript discharging part 32 after that. In addition, manuscript feeding part 3 is configured as retractable, and it functions as a platen cover that opens and closes upper surface of platen glass 22. When manuscript feeding part 3 is lifted upward, the upper surface of platen glass 22 can be opened, widely.

Body part 4 is provided with printing part 5 that records on recording paper P by an electrophotography process. Also, body part 4 is provided with sheet paper cassette 41, feed roller 42, paper sheet conveying path 43, conveying roller 44 and 45, and ejection roller 46. Feed roller 42, conveying roller 44 and 45, and ejection roller 46 function as a conveyance part that conveys recording paper P. Recording paper P contained in sheet paper cassette 41 is fed out one sheet at a time to paper sheet conveying path 43 by feed roller 42. Then, recording paper P is conveyed to printing part 5 by conveying roller 44. Then, recording paper P having recorded by printing part 5 is discharged to discharging space 40 by ejection roller 46.

Printing part 5 is provided with photo conductor drum 51, electrifying device 52, light scanning part 53, developing part 54, transfer roller 55, fixing part 56, and cleaning part 57. In an image formation by printing part 5, firstly, the front surface of photo conductor drum 51 is uniformly electrified by electrifying device 52. Then, based on the image data read by manuscript reading part 2, the front surface of photo conductor drum 51 is scanned by light scanning part 53. Thereby, an electrostatic latent image is made to form. Next, the electrostatic latent image formed on the front surface of photo conductor drum 51 is developed by developing part 54. Thereby, a toner image is made to form. While recording paper P fed out from sheet paper cassette 41 passes the nip part of photo conductor drum 51 and transfer roller 55, the toner image formed on the front surface of photo conductor drum 51 is transferred to recording paper P. While passing fixing part 56, heat fusing of the toner image transferred to recording paper P is performed for recording paper P.

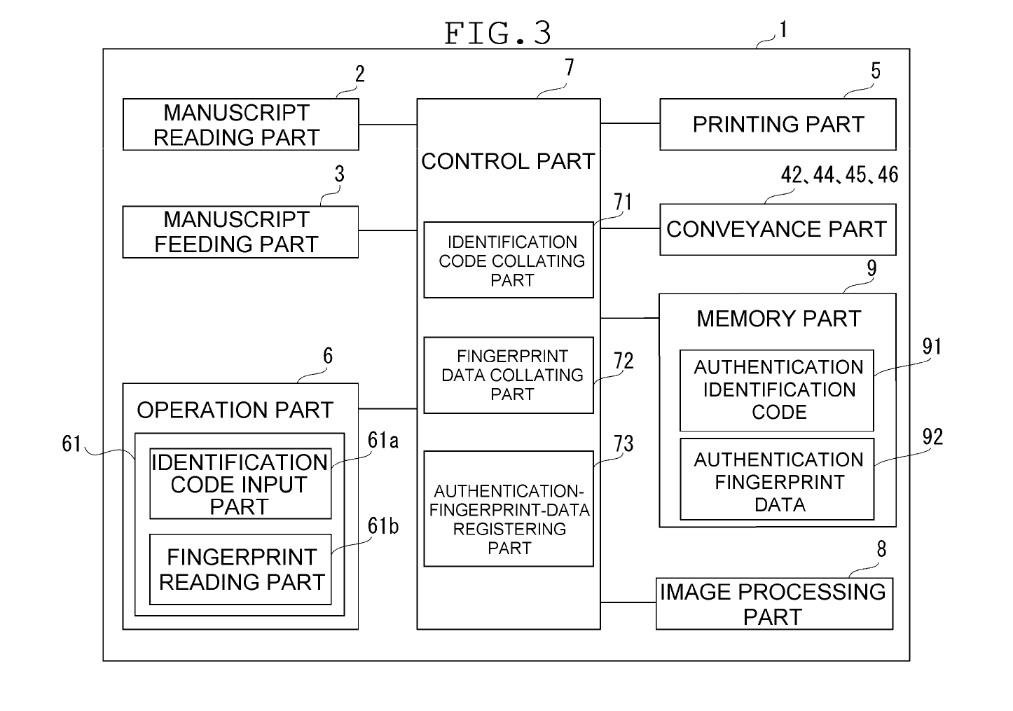

The block diagram showing the schematic structure of image forming apparatus 1 is shown in FIG. 3. Above-mentioned manuscript reading part 2, manuscript feeding part 3, a conveyance part (feed roller 42, conveying roller 44 and 45, ejection roller 46), printing part 5, and operation part 6 are connected to control part 7. Each part is operation-controlled by control part 7. Also, image processing part 8 and memory part 9 are connected to control part 7.

Image processing part 8 performs specified image processing for image data. Image processing part 8 performs a scaling process or an image improvement process, for example. An image improvement process is a process of gradation adjustment, density control, or the like.

Memory part 9 is a memory part having a non-transitory recording medium, such as semiconductor memory and HDD (Hard Disk Drive). The image data obtained by reading a manuscript by manuscript reading part 2 is stored in memory part 9. Various kinds of management data that includes a user authentication list for authenticating a user is stored in memory part 9. In the user authentication list, authentication identification code 91 and authentication fingerprint data 92 associated with authentication identification code 91 are registered. Also, in memory part 9, a use condition is stored as historical data with the authentication result.

Control part 7 is an information processing part, such as a microcomputer provided with the non-transitory recording medium. The non-transitory recording medium in control part 7 is ROM (Read Only Memory), RAM (Random Access Memory), or the like. In ROM, a control program for operation-controlling image forming apparatus 1 is stored. Control part 7 reads the control program stored in ROM and makes a control program expand to RAM. Thereby, control part 7 controls a whole device corresponding to specified instructions information inputted from operation part 6. Also, control part 7 functions as identification code collating part 71, fingerprint data collating part 72, and authentication-fingerprint-data registering part 73.

Identification code collating part 71 compares the identification code accepted the input by identification code input part 61a and authentication identification code 91 registered into the user authentication list in memory part 9. When the identification code accepted the input is registered into the user authentication list as authentication identification code 91, identification code collating part 71 authenticates the user, performs a login process, and permits use of image forming apparatus 1.

Fingerprint data collating part 72 compares the fingerprint data read by fingerprint reading part 61b and authentication fingerprint data 92 registered into the user authentication list in memory part 9. When the read fingerprint data is registered into the user authentication list as authentication fingerprint data 92, fingerprint data collating part 72 authenticates a user, performs a login process, and permits use of image forming apparatus 1.

Authentication-fingerprint-data registering part 73 is registered into a user authentication list when the identification code accepted the input is registered into the user authentication list as authentication identification code 91. In this case, authentication-fingerprint-data registering part 73 registers fingerprint data read by fingerprint reading part 61b into the user authentication list as the authentication fingerprint data associated into authentication identification code 91.

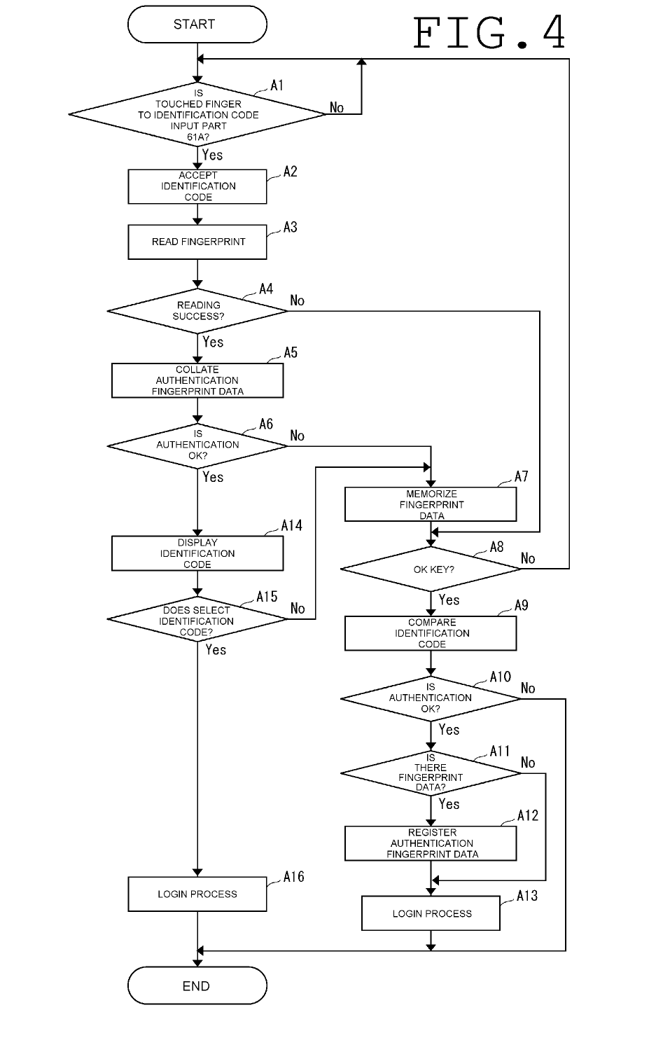

Next, the authentication operation in image forming apparatus 1 is explained in detail with reference to FIG. 4. When FIG. 4 is referred to, control part 7 displays an identification code input screen as shown in FIG. 2 on touch panel 61 at the time of starting to use. Control part 7 waits in the touch of the finger on identification code input part 61a provided in the identification code input screen, that is, the input of the identification code (Step A1).

In Step A1, if the finger is touched on identification code input part 61a, identification code input part 61a accepts the identification code corresponding to the point where being touched by the finger (Step A2). Identification code input part 61a outputs the accepted identification code to control part 7. In addition, it may be configured that an input coordinate is outputted to control part 7 from identification code input part 61a, and the identification code corresponding to the input coordinate is recognized by control part 7.

Simultaneously with Step A2, fingerprint reading part 61b identifies the fingerprint of the touched finger (step A3). Fingerprint reading part 61b is outputted the signal corresponding to the position of unevenness by the fingerprint to control part 7 as fingerprint data. That is, when a user touches touch panel 61 with the finger, an identification code is inputted, and the fingerprint data is read. In addition, when the fingerprint is taken, as mentioned above, in order to obtain a respective user's agreement, pop-up, or the like, is displayed on touch panel 61.

Next, control part 7 determines whether or not fingerprint reading by fingerprint reading part 61b is successful based on the fingerprint data inputted (step A4). Successful or not for the fingerprint reading by fingerprint reading part 61b can be determined in the size of the read fingerprint data, for example. As compared with the fingerprint data at the time of touching on touch panel 61 (identification code input part 61a) at the tip of a finger, where the fingerprint cannot be recognized, the size of the fingerprint data becomes large at the time of touching on touch panel 61 (identification code input part 61a) with a pad of the finger having a fingerprint. Accordingly, if the size of the fingerprint data shows greater than or equal to a specified size, it can be determined that fingerprint reading by fingerprint reading part 61b is succeeded. Also, if fingerprint data is less than the specified size, it can be determined that fingerprint reading by fingerprint reading part 61b is failed.

If fingerprint reading by fingerprint reading part 61b is successful in step A4, control part 7 functions as fingerprint data collating part 72. Fingerprint data collating part 72 compares the fingerprint data read by fingerprint reading part 61b and authentication fingerprint data 92 registered into the user authentication list in memory part 9 (step A5). Fingerprint data collating part 72 determines whether or not the read fingerprint data is registered into the user authentication list as authentication fingerprint data 92, that is, authentication is OK or not (Step A6).

In Step A6, it is explained a case where the read fingerprint data is not registered into the user authentication list as authentication fingerprint data 92 and authentication is NG. In this case, fingerprint data collating part 72 stores the read fingerprint data in memory part 9 (RAM in control part 7 is also possible) (Step A7). Then, control part 7 determines whether or not the identification code accepted in Step A2 is the OK key, which shows the end of the input (Step A8). In addition, if fingerprint reading by fingerprint reading part 61b fails in step A4, it reaches to Step A8, directly. In this case, control part 7 determines whether or not the identification code accepted in Step A2 is an OK key, which shows the end of the input.

At Step A8, if the accepted identification code is an OK key, which shows the end of the input, control part 7 functions as identification code collating part 71. Identification code collating part 71 compares the identification code accepted the input by identification code input part 61a with authentication identification code 91 registered into the user authentication list in memory part 9 (Step A9). Identification code collating part 71 is determined whether or not the identification code accepted the input is registered into the user authentication list as authentication identification code 91, that is, authentication is OK or not (Step A10). In Step A10, the case where the identification code accepted the input is not registered into the user authentication list as authentication identification code 91 and authentication is NG is explained. In this case, identification code collating part 71 completes authentication operation without permitting use of image forming apparatus 1.

In Step A10, the identification code accepted the input is registered into the user authentication list as authentication identification code 91 and authentication is OK, control part 7 determines whether or not the fingerprint data is stored in Step A7 exists (Step A11).

Further, in Step A11, when there is no fingerprint data is stored, control part 7 functions as authentication-fingerprint-data registering part 73. Authentication-fingerprint-data registering part 73 registers fingerprint data is stored in Step A7, as the authentication fingerprint data associated with authentication identification code 91 authenticated in Step A10, in a user authentication list (Step A12). Then, identification code collating part 71 authenticates the user, performs a login process, and permits use of image forming apparatus 1 (Step A13). Subsequently, identification code collating part 71 completes authentication operation. In addition, Step A11, if there is no fingerprint data is stored, it reaches to Step A13, directly. Identification code collating part 71 authenticates a user, performs a login process, and permits use of image forming apparatus 1. Thus, by a natural operation accompanying the input of the identification code, the user's authentication fingerprint data can be registered. Accordingly, for a user unfamiliar to machine operation, registration of authentication fingerprint data is possible without being conscious of special operation.

If touch panel 61 is touched with pad of the finger with the fingerprint and the identification code is inputted, usually, a plurality of fingerprint data is stored in Step A7. These plurality of fingerprint data are obtained on various grounding conditions (contact state of the finger and touch panel 61). Accordingly, authentication-fingerprint-data registering part 73 selects the highest-precision fingerprint data (for example, fingerprint data with the largest size) from the plurality of fingerprint data stored in Step A7. Authentication-fingerprint-data registering part 73 registers selected fingerprint data into the user authentication list as the authentication fingerprint data. Also, authentication-fingerprint-data registering part 73 generates high-precision fingerprint data (for example, fingerprint data with large size) by piling up the plurality of fingerprint data stored in Step A7. Authentication-fingerprint-data registering part 73 may register the generated fingerprint data into the user authentication list as the authentication fingerprint data.

In Step A6, it is explained a case where the read fingerprint data is registered into the user authentication list as authentication fingerprint data 92 and authentication is OK. Fingerprint data collating part 72 displays the authentication identification code associated with authentication fingerprint data 92 on touch panel 61 (Step A14). Then, fingerprint data collating part 72 accepts selection of the authentication identification code, which the user is to input (Step A15). In addition, if a plurality of authentication identification codes are associated with authentication fingerprint data 92 in the user authentication list, in Step A14, the plurality of authentication identification codes are displayed on touch panel 61. Then, the user selects the authentication identification code, which is to input, from the plurality of displayed authentication identification codes.

In Step A15, if the authentication identification code is selected, fingerprint data collating part 72 authenticates the user by the authentication identification code selected in Step A15 and performs the login process. Fingerprint data collating part 72 permits use of image forming apparatus 1 (Step A16), and completes authentication operation. In addition, in case that an environment where only one identification code is assigned for the user, neither display of the authentication identification code nor the registration of selection may be performed in Steps A14 and A15, and it may be reached to Step A16. This may performed in case that the read fingerprint data is registered into the user authentication list as authentication fingerprint data 92 in Step A6 and authentication is OK,

In Step A15, if an authentication identification code is not selected, it reaches to Step A7. Then, fingerprint data collating part 72 stores the read fingerprint data in memory part 9 (RAM of control part 7 is also possible.) In addition, if an authentication identification code is not selected in Step A15, even if fingerprint reading by fingerprint reading part 61b is succeeded, the fingerprint data authentication in Step A4 and A5 are not performed. Then, it reaches to Step A7. Thereby, corresponding to the same authentication fingerprint data, the plurality of authentication identification codes can be registered. Also, in Step A15, it may be selected that canceling the already registered authentication identification code, registering the plurality of identification codes corresponding to the same authentication fingerprint data, or not registering the authentication identification code in this time.

Also, after Step A10, it may be determined whether or not the authentication fingerprint data associated with the identification code, which authentication is OK, is already registered. If other authentication fingerprint data, that is, the authentication fingerprint data being not correspond with the fingerprint data stored in Step A7, is already registered, identification code collating part 71 may not permit use of image forming apparatus 1 and complete the authentication operation. In this case, authentication-fingerprint-data registering part 73 does not register fingerprint data is stored in Step A7 into the user authentication list as authentication fingerprint data. Thereby, for authentication identification code 91, which authentication fingerprint data are associated with and is stored, an unauthorized use can be prevented even if the identification code is leaked to another user.

As explained above, according to the present embodiment, it is an authentication apparatus that authenticates a user by accepting input of the identification code by touch operation and by comparing the inputted identification code (hereinafter, it is called an input identification code) and authentication identification code 91 stored in memory part 9. The authentication apparatus is provided with fingerprint reading part 61b, fingerprint data collating part 72, and authentication-fingerprint-data registering part 73. Fingerprint reading part 61b reads fingerprint data at the time of the touch operation for the identification code. Fingerprint data collating part 72, by comparing fingerprint data read by fingerprint reading part 61b with authentication fingerprint data 92 associated with authentication identification code 91 and stored in memory part 9, specifies authentication identification code 91, and authenticates a user. Authentication-fingerprint-data registering part 73, when authentication fingerprint data 92 that correspond with the fingerprint data read by fingerprint reading part 61b is not stored, and when authentication identification code 91 that corresponds with the input identification code is stored, associates fingerprint data read by fingerprint reading part 61b with authentication identification code 91 that corresponds with the input identification code as authentication fingerprint data 92 and stores it in memory part 9. According to this configuration, by natural operation accompanying the input of an identification code, the authentication fingerprint data for comparing with the read fingerprint data can be registered, easily. Therefore, a user, who is unfamiliar to apparatus operation, can register authentication fingerprint data without being conscious of special operation.

Further, according to the present embodiment, authentication-fingerprint-data registering part 73 selects the highest precision finger print data from the plurality of fingerprint data read by fingerprint reading part 61b. Authentication-fingerprint-data registering part 73 stores the selected fingerprint data in memory part 9 as authentication fingerprint data 92. Also, authentication-fingerprint-data registering part 73 may generate high-precision fingerprint data based on the plurality of fingerprint data read by fingerprint reading part 61b. Authentication-fingerprint-data registering part 73 may store the generated fingerprint data in memory part 9 as authentication fingerprint data 92. By this configuration, the plurality of fingerprint data obtained on various grounding conditions with the input of the identification code becomes to have high precision. Accordingly, more high-precision authentication fingerprint data can be registered, naturally.

Further, according to the present embodiment, fingerprint data collating part 72 displays the plurality of authentication identification codes 91 on touch panel 61 when the plurality of authentication identification codes 91 are specified. Fingerprint data collating part 72 accepts selection of authentication identification code 91 being to input from the plurality of displayed authentication identification codes 91. By this configuration, the plurality of authentication identification codes can be set up for the same user.

In summary, in a typical apparatus, it is necessary to register the fingerprint data for collation for comparing with the read fingerprint data in advance. Registration of the fingerprint data for collation is carried out by administrator authority, generally, and thus the registering operation of the fingerprint data for collation becomes complicated.

The present disclosure is accomplished in view of this respect, and the subject is providing the authentication apparatus that can register the fingerprint data for collation for comparing with the read fingerprint data, easily.

According to the present disclosure, the effect that the authentication fingerprint data for comparing with the read fingerprint data by the natural operation accompanying the input of the identification code can be registered, easily, is produced.

In addition, it is clear that the present disclosure is not limited to each above-mentioned embodiment, but each embodiment may be suitably changed within the limits of the technology conception in the present disclosure.

What is claimed is:

1. An authentication apparatus that authenticates a user by comparing an input identification code inputted by touch operation with an authentication identification code stored in a memory part, comprising:
a fingerprint reading part that reads fingerprint data at time of the touch operation of the input identification code;
an fingerprint data collating part that specifies the authentication identification code and authenticates the user by comparing fingerprint data read by the fingerprint reading part and authentication fingerprint data being associated with the authentication identification code and being stored in the memory part; and
authentication-fingerprint-data registering part that, when the authentication fingerprint data that corresponds with the fingerprint data read by the fingerprint reading part is not stored and the authentication identification code that corresponds with the input identification code is stored, associates the fingerprint data read by the fingerprint reading part with the authentication identification code corresponding with the input identification code as the authentication fingerprint data and stores in the memory part.

2. The authentication apparatus according to claim 1, wherein
the authentication-fingerprint-data registering part selects finger print data having highest precision from a plurality of fingerprint data read by the fingerprint reading part and stores selected fingerprint data in the memory part as the authentication fingerprint data.

3. The authentication apparatus according to claim 1, wherein
the authentication-fingerprint-data registering part generates high-precision fingerprint data based on the plurality of fingerprint data read by the fingerprint reading part and stores generated high-precision fingerprint data in the memory part as the authentication fingerprint data.

4. The authentication apparatus according to claim 3, wherein
the fingerprint data collating part, when a plurality of authentication identification codes are specified, displays the plurality of authentication identification codes on a display part and accepts selection of the authentication identification code that is to input from displayed plurality of authentication identification codes.

5. An authentication method performed by the authentication apparatus that authenticates a user by comparing an input identification code inputted by touch operation with an authentication identification code stored in the memory part, comprising the steps of:
reading fingerprint data at time of the touch operation of the input identification code;
specifying an authentication identification code and authenticating the user by comparing read fingerprint data with authentication fingerprint data associated with the authentication identification code and making store in the memory part; and
associating, when the authentication fingerprint data the correspond with the read fingerprint data is not stored and the authentication identification code that corresponds with the input identification code is stored, read fingerprint data with the authentication identification code corresponding with the input identification code as the authentication fingerprint data and making store in the memory part.
